(19) United States
(12) Patent Application Publication
(10) Pub. No.: US 2010/0197226 A1
(43) Pub. Date: Aug. 5, 2010

(54) Mobile Station Having Wireless Communication and Radio Frequency Tag Detection Capability

(75) Inventors: Stuart O. Goldman, Scottsdale, AZ (US); James P. Runyon, Wheaton, IL (US); Carlos C. Solari, Shenandoah, VA (US); Richard E. Krock, Naperville, IL (US); Anil P. Macwan, Naperville, IL (US)

Correspondence Address: CARLSON, GASKEY & OLDS, P.C./Alcatel-Lucent, 400 W MAPLE RD, SUITE 350, BIRMINGHAM, MI, 48009, US

(73) Assignee: Alcatel-Lucent USA Inc., Murray Hill, NJ (US)

(21) Appl. No.: 12/362,772

(22) Filed: Jan. 30, 2009

(51) Int. Cl. H04B 7/00

(52) U.S. Cl. 455/41.2

(57) ABSTRACT

An exemplary mobile station has a transceiver portion configured to communicate over an uplink and a downlink. A detector portion is configured to detect a radio frequency tag. An exemplary method of using a mobile station includes selectively conducting wireless communications over an uplink and a downlink. The mobile station is also selectively used to detect at least one radio frequency tag.

### FIELD OF THE INVENTION

This invention generally relates to communication. More particularly, this invention relates to wireless communications.

### DESCRIPTION OF THE RELATED ART

Wireless communication systems are well known and in widespread use. Typical cellular communication arrangements include a plurality of base station transceivers strategically positioned to provide wireless communication coverage over selected geographic areas. A mobile station (e.g., notebook computer, personal digital assistant or cellular phone) communicates with a base station transceiver using an over-the-air interface. The communications from a mobile station to the base station are considered to be in an uplink direction and communications to the mobile station from the base station are in a downlink direction.

Wireless communication systems have become increasingly capable of servicing a wider variety of subscriber needs. For example, it is now possible for many mobile stations to be used for voice, data, Internet and messaging services. Mobile stations typically include two-way communication functionality (e.g., transmitting on an uplink and receiving on a downlink) for such services.

### SUMMARY

An exemplary mobile station has a transceiver portion configured to communicate over an uplink and a downlink. A detector portion is configured to detect a radio frequency tag.

An exemplary method of using a mobile station includes selectively conducting wireless communications over an uplink and a downlink. The mobile station is also selectively used to detect at least one radio frequency tag.

The various features and advantages of the disclosed examples will become apparent to those skilled in the art from the following detailed description. The drawings that accompany the detailed description can be briefly described as follows.

### BRIEF DESCRIPTION OF THE DRAWINGS

FIG. 1 schematically illustrates selected communication equipment useful with an embodiment of this invention.

FIG. 2 schematically illustrates selected portions of a mobile station shown in FIG. 1.

FIG. 3 is a flow chart diagram summarizing one example approach.

### DETAILED DESCRIPTION

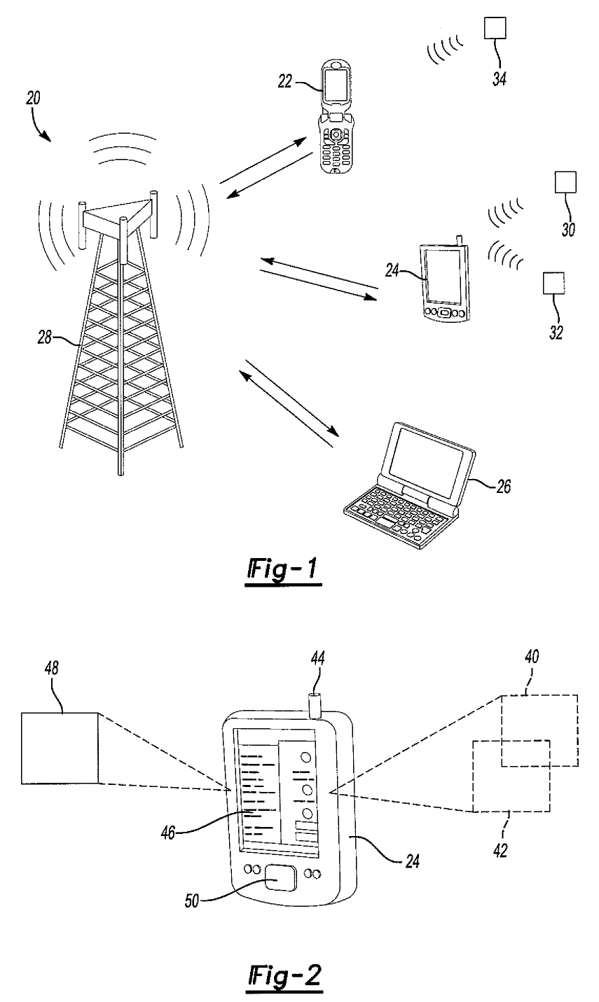

FIG. 1 shows selected portions of a wireless communication system 20. A plurality of mobile stations 22, 24 and 26 are configured to communicate with a base station 28. In one example, the base station 22 is part of a cellular communication system. In another example, the base station is useful for wireless fidelity, Bluetooth or local area network communications.

As schematically shown, the mobile stations 22, 24 and 26 communicate with the base station 28 over an uplink (from the mobile to the base station) and a downlink (from the base station to the mobile). The wireless communications in one example comprise at least one of voice or data transmissions on the uplink and the downlink. Each of the mobile stations 24, 26 and 28 comprises transceiver functionality for conducting the wireless communications with the base station 22.

At least the mobile station 24 also has a capability to detect at least one of a plurality of radio frequency tag (RFT) devices 30, 32 and 34. Known RFT devices and known techniques for detecting RFTS are used in one example. The illustrated example mobile station 24 is capable of detecting a plurality of radio frequency tags and provides a user with a variety of options for utilizing that capability.

In many cases, detecting RFTS involves only signal detection or reception at the mobile station. In such examples, the RFT detecting functionality is distinct from other wireless communications that require two-way (i.e., uplink and downlink) signaling between the mobile station and another device. In some examples, a RFT may respond to an inquiry or trigger signal received from a mobile station as part of the detection process. In such a case, two-way communications are used by the mobile station for effective RFT tracking or detection.

FIG. 2 schematically shows selected portions of the mobile station 24. A transceiver portion 40 is configured for the functionality necessary for conducting wireless communications with the base station 28. A detector portion 42 is configured for the functionality necessary for detecting the RFTS. The transceiver portion 40 and the detector portion 42 are schematically shown as at least partially overlapping and at least partially distinct from each other for purposes of discussing the unique features of each such capability of the mobile station 24. The actual hardware, software, firmware or combination of these utilized to realize the capabilities of the example transceiver portion 40 and detector portion 42 may be partially or entirely the same or may be partially or entirely distinct. In one example, the RFT detection capability of the mobile station 24 and the wireless communication capability are realized using as many common components of the mobile station 24 as possible.

For example, the mobile station 24 includes an antenna 44, a display 46 that is also a user-interface touch screen in this example, a battery 48 and a speaker 50. In one example, the detector portion 42 and the transceiver portion 40 each rely upon those components for corresponding portions of their operations as needed. For example, the transceiver portion 40 operates based upon signals transmitted from and received by the antenna 44 and the detector portion 42 utilizes RFT signals detected through the antenna 44. The battery 48 is the single power source for both portions 40 and 42. The display and user interface 46 allows a user to control use of the transceiver portion 40 and the detector portion 42, respectively. The speaker 50 allows a user to hear received wireless communications and to hear indications regarding detection or attempted detection of an RFT.

Using common components of the mobile station 24 for the functionality of the detector portion 42 and the transceiver portion 40 in one example includes having at least some software, firmware or both selectively used by both portions 42 and 40. In one such example, the detector portion 42 and the transceiver portion are at least partially realized as part of the same processor associated with the software that provides the respective functionalities.

For example, the components used to allow the transceiver portion 40 to receive signals on a downlink to the mobile station 24 and to process such received signals are also used to allow the detector portion 42 to receive RFT signals and to process them for detecting a RFT. The same components used to allow a user to indicate a desire to place or accept a wireless communication call are also used to allow the user to control whether a particular RFT is monitored. Given this description, those skilled in the art will realize how to integrate or separate the functionalities of the transceiver portion 40 and the detector portion 42.

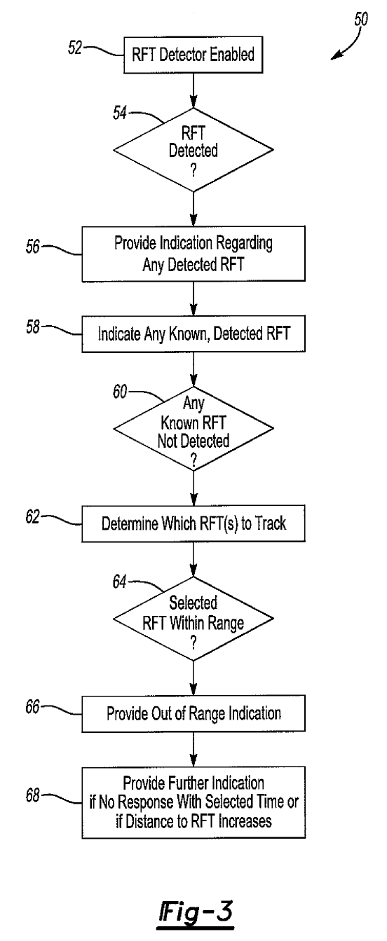

FIG. 3 includes a flow chart diagram 50 summarizing one example approach for managing the RFT detection capabilities of the mobile station 24. The detector portion 42 in this example is selectively activated or enabled according to a user's desires. At 52, the detector portion 42 is activated. At 54, an attempt is made to detect any RFTS within a detection range of the mobile station 24. At 56, an indication is provided (on the display 46, by the speaker 50 or both, for example) regarding any detected RFTS. This example includes a determination at 58 whether a detected RFT is a known device and such information in a corresponding indication is provided by the mobile station 24.

One example includes allowing a user to predetermine an identity for each RFT of interest to that user and the mobile station 24 provides that information as appropriate. For example, the mobile station 24 in FIG. 1 currently detects the presence of the RFTS 30 and 32 because they are within a detectable range of the mobile station 24. In one example, the RFT 30 is on a bracelet worn by a daughter of the user of the mobile station 24. The RFT 32 in the same example is on a collar worn by a pet of the user. The speaker 50 provides an audible indication, the display 46 provides a visible indication or a combination of such indications are provided to inform the user of the mobile station 24 that the daughter's RFT 30 and the RFT 32 worn by the pet is within the detectable range.

The illustrated example includes a determination at 60 whether any known RFT previously identified by the user (and for which corresponding information has been input by the user so that it has been provided to the detector portion 42) is not currently detectable.

At 62, a user input is received (or a timer expires waiting for user input) to determine which, if any, of the known or detected RFTS should be monitored. This allows a user, for example, to indicate a desire to only monitor whether the daughter's RFT 30 is within a detectable range while ignoring the pet's RFT 32 and the RFT 34.

When at least one RFT should be monitored, the detector portion 42 at least periodically attempts to detect the selected RFT at 64. Periodic checks for detecting the RFT are used in one example while continuous monitoring is used in another example. Whenever any such RFT is not detected (or is detected at a range that is outside of an acceptable range), it is presumed to be cause for concern and the user of the mobile station is notified at 66 with an audible indication using the speaker 50, a visible indication on the display 46 or both. In one example, an increasingly noticeable indication is provided at 68. This may be until a highest indication level is reached or a user response to the indication is input into the mobile station 24 (using the user interface 46, for example). This feature allows for providing a user with an increased sense of reason for concern that a RFT is outside of a desired range of the mobile station 24, for example. In one example, once a currently monitored RFT becomes undetectable (e.g., out of range), a first indication is provided for a selected time. Once that time expires, an increased (e.g., louder) indication is provided. In one example, a more noticeable indication is provided as the distance between a monitored RFT and the mobile station 24 increases.

One example provides a user with the ability to customize the type of indication and the manner in which the indication is provided. One example includes providing a user with the ability to customize the range used for detection or to specify times during which a particular RFT should be monitored according to a selected schedule. Other user options in one example include an ability to stop monitoring a selected RFT or to set a monitor timer after which monitoring automatically stops.

One feature of the illustrated example is that it allows an individual having a mobile station for wireless communications to be able to track RFTS with the same device. This allows for RFT tracking without requiring a separate RFT monitoring device to be carried about by a user. Instead, the mobile station with RFT detector capabilities also provides a variety of wireless communication capabilities. As indicated above many of the components of the mobile station used for RFT detection and tracking can be the same as those used for wireless communications.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. A method of using a mobile station, comprising the steps of:
selectively using the mobile station for wireless communication over an uplink and a downlink; and
selectively using the mobile station for detecting a radio frequency tag.

2. The method of claim 1, wherein the mobile station comprises a plurality of components and the method comprises
using at least selected ones of the components for the wireless communication and the detecting.

3. The method of claim 1, comprising
providing an indication when at least one of the following conditions is met:
(i) the mobile station is unable to detect the radio frequency tag, or
(ii) a distance between the mobile station and the radio frequency tag exceeds a selected threshold.

4. The method of claim 3, comprising
providing a first indication responsive to at least on of the conditions being met; and
providing a second, different indication responsive to a predetermined second condition being met.

5. The method of claim 4, wherein the second condition comprises at least one of
a time elapsing since the first indication was provided, or
a distance between the mobile station and the radio frequency tag exceeding a second, greater threshold.

6. The method of claim 1, comprising
detecting at least one of a plurality of radio frequency tags by the mobile station, each of the plurality of radio frequency tags having a known identifier; and
providing an indication regarding the detecting and the corresponding identifier.

7. The method of claim 6, comprising
at least periodically determining whether the detected radio frequency tag is still detectable until a response to the provided indication corresponds to a command to stop monitoring the detected radio frequency tag.

8. The method of claim 1, comprising
detecting a plurality of radio frequency tags by the mobile station; and
providing an indication that uniquely identifies each detected radio frequency tag.

9. A mobile station device, comprising:
a transceiver portion configured for wireless communication over an uplink and a downlink; and
a detector portion configured to detect a radio frequency tag.

10. The device of claim 9, comprising a plurality of components and wherein the detector portion and the transceiver portion both interact with at least selected ones of the components.

11. The device of claim 9, wherein the plurality of components include a battery, an antenna, a display, a user interface and a speaker and wherein the detector portion uses the battery, the antenna, the display, the user interface and the speaker for at least corresponding selected portions of detecting the radio frequency tag and the transceiver portion uses the battery, the antenna, the display, the user interface and the speaker for at least corresponding selected portions of the wireless communication.

12. The device of claim 9, wherein the detector portion is configured to provide an indication when at least one of the following conditions is met:
(i) the mobile station is unable to detect the radio frequency tag, or
(ii) a distance between the mobile station and the radio frequency tag exceeds a selected threshold.

13. The device of claim 12, wherein the detector portion is configured to
provide a first indication responsive to at least on of the conditions being met; and
provide a second, different indication responsive to a predetermined second condition being met.

14. The device of claim 13, wherein the second condition comprises at least one of
a time elapsing since the first indication was provided, or
a distance between the mobile station and the radio frequency tag exceeding a second, greater threshold.

15. The device of claim 9, wherein the detector portion is configured to
detect at least one of a plurality of radio frequency tags, each of the plurality of radio frequency tags having a known identifier; and
provide an indication regarding the detected radio frequency tag and the corresponding identifier.

16. The device of claim 15, wherein the detector portion is configured to
at least periodically determine whether the detected radio frequency tag is still detectable until a response to the provided indication corresponds to a command to stop monitoring the detected radio frequency tag.

17. The device of claim 9, comprising a processor that is configured to process information for conducting the wireless communication and information for detecting the radio frequency tag.

18. The device of claim 17, wherein the detector portion comprises software executable by the processor.

19. The device of claim 9, wherein the transceiver portion comprises at least one component of the mobile station and the detector portion comprises at least one other component of the mobile station.

20. The device of claim 18, wherein the at least one component and the at least one other component both interact with other components of the mobile station.
